(19) United States
(12) Patent Application Publication
(10) Pub. No.: US 2013/0082554 A1
(43) Pub. Date: Apr. 4, 2013

(54) SPINDLE MOTOR

(71) Applicant: Chang Jo YU, Suwon (KR)

(72) Inventor: Chang Jo YU, Suwon (KR)

(73) Assignee: SAMSUNG ELECTRO-MECHANICS CO., LTD., Suwon (KR)

(21) Appl. No.: 13/316,912

(22) Filed: Dec. 12, 2011

(30) Foreign Application Priority Data
Sep. 30, 2011 (KR) 10-2011-0099655

(51) Int. Cl. H02K 7/08

(52) U.S. Cl. 310/90

(57) ABSTRACT

There is provided a spindle motor including: a lower thrust member fixed to a base member; a shaft fixed to at least one of the lower thrust member and the base member; a sleeve formed above the lower thrust member and provided to be rotatable with the shaft, wherein the sleeve, together with the lower thrust member, forms a lubricating fluid liquid-vapor interface and a lower sealing portion; a rotor hub coupled to the sleeve and rotating together therewith; and an upper thrust member fixed to an upper end portion of the shaft, wherein the upper thrust member, together with the sleeve, forms a lubricating fluid liquid-vapor interface and an upper sealing portion, wherein either of the upper sealing portion and the lower sealing portion has a greater volume of sealed lubricating fluid than the other.

### CROSS-REFERENCE TO RELATED APPLICATIONS

This application claims the priority of Korean Patent Application No. 10-2011-0099655 filed on Sep. 30, 2011, in the Korean Intellectual Property Office, the disclosure of which is incorporated herein by reference.

### BACKGROUND OF THE INVENTION

1. Field of the Invention

The present invention relates to a spindle motor, and more particularly, to a fixed-shaft type spindle motor.

2. Description of the Related Art

In general, a fixed-shaft type spindle motor, with a shaft having excellent vibration characteristics, fixed on a box of a hard disk driving device is mounted in an information recording and reproducing device such as a hard disk driving device for a server.

That is, the shaft is fixed to the spindle motor mounted on the hard disk driving device for a server in order to prevent an amplitude of a rotor from increasing due to external vibrations. This is because, when the amplitude of the rotor increases, information stored on a disk may be damaged and may not be able to be recorded or read.

When a fixed shaft is installed in a spindle motor, various liquid-vapor interfaces are formed to configure a fluid dynamic-pressure bearing in which lubricating fluid is filled. However, these liquid-vapor interfaces maybe moved due to the influence of a dynamic-pressure groove during the rotation of the spindle motor. When the movement of the liquid-vapor interfaces cannot be appropriately controlled, lubricating fluid may leak therefrom.

When the amount of lubricating fluid in a fluid dynamic-pressure bearing is reduced in order to prevent the lubricating fluid from leaking, the lifetime of the spindle motor may be reduced due to the vaporization of the lubricating fluids. Thus, there is a need for a structure for storing a sufficient amount of lubricating fluid.

### SUMMARY OF THE INVENTION

An aspect of the present invention provides a spindle motor capable of storing a sufficient amount of lubricating fluid without leakage of lubricating fluids. That is, the spindle motor includes a sealing portion with a large volume for intentionally storing a sufficient amount of lubricating fluid, thereby preventing a reduction in performance of a dynamic-pressure bearing assembly.

The present invention is not limited thereto and may have various objects that are achieved according to various embodiments of the present invention as described below.

According to an aspect of the present invention, there is provided a spindle motor including: a lower thrust member fixed to a base member; a shaft fixed to at least one of the lower thrust member and the base member; a sleeve formed above the lower thrust member and provided to be rotatable with the shaft, wherein the sleeve, together with the lower thrust member, forms a lubricating fluid liquid-vapor interface and a lower sealing portion; a rotor hub coupled to the sleeve and rotating together with the sleeve; and an upper thrust member fixed to an upper end portion of the shaft, wherein the upper thrust member, together with the sleeve, forms a lubricating fluid liquid-vapor interface and an upper sealing portion, wherein either of the upper sealing portion and the lower sealing portion has a greater volume of sealed lubricating fluid than the other.

An upper end portion of the sleeve may include an upper inclination portion, wherein an external diameter of an upper portion of the upper inclination portion is greater than an external diameter of a lower portion thereof so that the upper inclination portion and the upper thrust member form together a liquid-vapor interface. A lower end portion of the sleeve may include a lower inclination portion, wherein an external diameter of a lower portion of the lower inclination portion may be greater than an external diameter thereof so that the lower inclination portion and the lower thrust member form together a liquid-vapor interface.

Each of the upper thrust member and the lower thrust member may include a body having an inner surface coupled to the shaft, and a protrusion portion that extends from the body and forms a liquid-vapor interface together with each of the upper inclination portion and the lower inclination portion.

At least one of a bottom surface of the upper thrust member and a top surface of the sleeve or at least one of a top surface of the lower thrust member and a bottom surface of the sleeve may include auxiliary thrust dynamic-pressure grooves formed therein.

A thrust dynamic-pressure groove positioned in a sealing portion with a small sealing volume of lubricating fluid from among the upper sealing portion and the lower sealing portion may have a greater lubricating fluid pumping force than a lubricating fluid pumping force of a thrust dynamic-pressure groove positioned in the other sealing portion.

The thrust dynamic-pressure groove positioned in a sealing portion with a small sealing volume of lubricating fluid from among the upper sealing portion and the lower sealing portion may have a smaller depth than the thrust dynamic-pressure groove positioned in the other sealing portion.

An axial interval between the sleeve and a thrust member positioned in a sealing portion with a small sealing volume of lubricating fluid from among the upper sealing portion and the lower sealing portion may be smaller than an axial interval between the sleeve and a thrust member positioned in the other sealing portion.

The spindle motor may further include a circulation hole formed through a top surface of the sleeve to a bottom surface of the sleeve.

At least one of a bottom surface of the upper thrust member and a top surface of the sleeve or at least one of a top surface of the lower thrust member and a bottom surface of the sleeve may include auxiliary thrust dynamic-pressure grooves formed outwardly, in a radial direction, of top and lower surfaces of the sleeve based on the circulation hole.

The auxiliary thrust dynamic-pressure groove positioned in a sealing portion with a small sealing volume from among the upper sealing portion and the lower sealing portion may have a greater lubricating fluid pumping force than a lubricating fluid pumping force of the thrust dynamic-pressure groove positioned in the other sealing portion.

The auxiliary thrust dynamic-pressure groove positioned in a sealing portion with a small sealing volume of lubricating fluid from among the upper sealing portion and the lower sealing portion may have a smaller depth than the thrust dynamic-pressure groove positioned in the other sealing portion.

With regard to a portion positioned outwardly, in the radial direction, of the top and lower surfaces of the sleeve based on the circulation hole, an axial interval between the sleeve and a thrust member positioned in a sealing portion with a small sealing volume of lubricating fluid from among the upper sealing portion and the lower sealing portion may be smaller than an axial interval between the sleeve and a thrust member positioned in the other sealing portion.

An end portion of the sleeve, positioned in a sealing portion with a great sealing volume of lubricating fluid from among the upper sealing portion and the lower sealing portion, may include a step portion that is formed outwardly, in the radial direction, of the sleeve based on the circulation hole, and an axial interval between the sleeve and a thrust member positioned at the sealing portion may be greater than an axial interval between the sleeve and a thrust member that is positioned in the other sealing portion.

The circulation hole and a bearing gap formed by the sleeve and the shaft may include a connection hole connected therebetween.

The rotor hub may include a rotor hub body including an insertion portion into which the upper thrust member is inserted; an installation portion that extends from an edge of the rotor hub body and has an inner surface on which a magnet assembly is installed; and an extension portion that extends outwards in a radial direction from an end of the installing portion.

The sleeve and the rotor hub may be integrated together.

According to another aspect of the present invention, there is provided a spindle motor including: a base member; a shaft fixed to the base member; a sleeve including a bearing unit installed to be rotatable with the shaft, and an upper groove portion and a lower groove portion formed in an upper portion and a lower portion of the sleeve, respectively; upper and lower thrust members fixed to the shaft and respectively accommodated in the upper and lower groove portions, the upper and lower thrust members forming, outwardly in a radial direction, a lubricating fluid liquid-vapor interface, together with an inner circumferential surface of the sleeve, and forming upper and lower sealing portions, respectively; and ; and a rotor hub coupled to the sleeve and rotating together with the sleeve, wherein either of the upper sealing portion and the lower sealing portion has a greater volume of sealed lubricating fluid than the other.

The sleeve and the rotor hub may be integrated together.

The upper thrust member may include an upper inclination portion, wherein an external diameter of an upper portion of the upper inclination portion is smaller than an external diameter of a lower portion thereof so that the upper inclination portion and the sleeve form together the liquid-vapor interface, and the lower thrust member end portion of the sleeve may include a lower inclination portion, wherein an external diameter of a lower portion of the lower inclination portion may be smaller than an external diameter of an upper portion thereof so that the lower inclination portion and the sleeve form together the liquid-vapor interface.

At least one of a bottom surface of the upper thrust member and an upper grooved bottom surface of the sleeve or at least one of a top surface of the lower thrust member and a lower grooved bottom surface of the sleeve may include a thrust dynamic-pressure groove formed therein.

The thrust dynamic-pressure groove positioned in a sealing portion with a small sealing volume from among the upper sealing portion and the lower sealing portion may have a greater lubricating fluid pumping force than a lubricating fluid pumping force of the thrust dynamic-pressure groove positioned in the other sealing portion.

The thrust dynamic-pressure groove positioned in a sealing portion with a small sealing volume of lubricating fluid from among the upper sealing portion and the lower sealing portion may have a smaller depth than the thrust dynamic-pressure groove positioned in the other sealing portion.

An axial interval between the sleeve and a thrust member positioned in a sealing portion with a small sealing volume of lubricating fluid from among the upper sealing portion and the lower sealing portion may be smaller than an axial interval between the sleeve and a thrust member positioned in the other sealing portion.

The spindle motor may further include a circulation hole formed from an upper groove portion of the sleeve to a lower groove portion of the sleeve.

At least one of a bottom surface of the upper thrust member and an upper grooved bottom surface of the sleeve or at least one of a top surface of the lower thrust member and a lower grooved bottom surface of the sleeve may include auxiliary thrust dynamic-pressure grooves formed outwardly, in a radial direction, of top and lower surfaces of the sleeve based on the circulation hole.

The auxiliary thrust dynamic-pressure groove positioned in a sealing portion with a small sealing volume from among the upper sealing portion and the lower sealing portion may have a greater lubricating fluid pumping force than a lubricating fluid pumping force of the thrust dynamic-pressure groove positioned in the other sealing portion.

The auxiliary thrust dynamic-pressure groove positioned in a sealing portion with a small sealing volume of lubricating fluid from among the upper sealing portion and the lower sealing portion may have a smaller depth than a thrust dynamic-pressure groove positioned in the other sealing portion.

With regard to a portion positioned outwardly, in the radial direction, of the top and lower surfaces of the sleeve based on the circulation hole, an axial interval between a

grooved bottom surface of the sleeve and a thrust member positioned in a sealing portion with a small sealing volume of lubricating fluid from among the upper sealing portion and the lower sealing portion may be smaller than an axial interval between a grooved bottom surface of the sleeve and a thrust member positioned in the other sealing portion.

A grooved bottom surface of the sleeve, positioned in a sealing portion with a great sealing volume of lubricating fluid from among the upper sealing portion and the lower sealing portion, may include a step portion that is formed outwardly, in the radial direction, of the sleeve based on the circulation hole, and an axial interval between the grooved bottom surface of the sleeve and a thrust member at the sealing portion may be greater than an axial interval between the grooved bottom surface of the sleeve and a thrust member that is positioned in the other sealing portion.

The spindle motor may further include a connection hole through which the circulation hole and a bearing gap formed by the sleeve and the shaft are connected.

The rotor hub may include a rotor hub body having an insertion portion into which the sleeve is inserted; an installation portion that extends from an edge of the rotor hub body and has an inner surface on which a magnet assembly is installed; and an extension portion that extends outwards in a radial direction from an end of the installing portion.

According to another aspect of the present invention, there is provided a record-disk driving apparatus including the spindle motor according to the above-mentioned embodiment.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a spindle motor according to an embodiment of the present invention;

FIG. 2 is an enlarged cross-sectional view of a portion ‘A’ of FIG. 1;

FIGS. 3 and 4 are partial exploded perspective views illustrating a sleeve, an upper thrust member and a lower thrust member of FIG. 1;

FIG. 5 is a diagram for explaining an operation of the spindle motor of FIG. 1, according to an embodiment of the present invention;

FIG. 6 is a schematic cross-sectional view of a spindle motor according to another embodiment of the present invention;

FIG. 7 is an enlarged cross-sectional view of a portion ‘A′’ of FIG. 6;

FIGS. 8 and 9 are partial exploded perspective views illustrating a sleeve, an upper thrust member and a lower thrust member of FIG. 6; and

FIGS. 10A and 10B are schematic cross-sectional views of record-disk driving apparatuses including motors according to embodiments of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

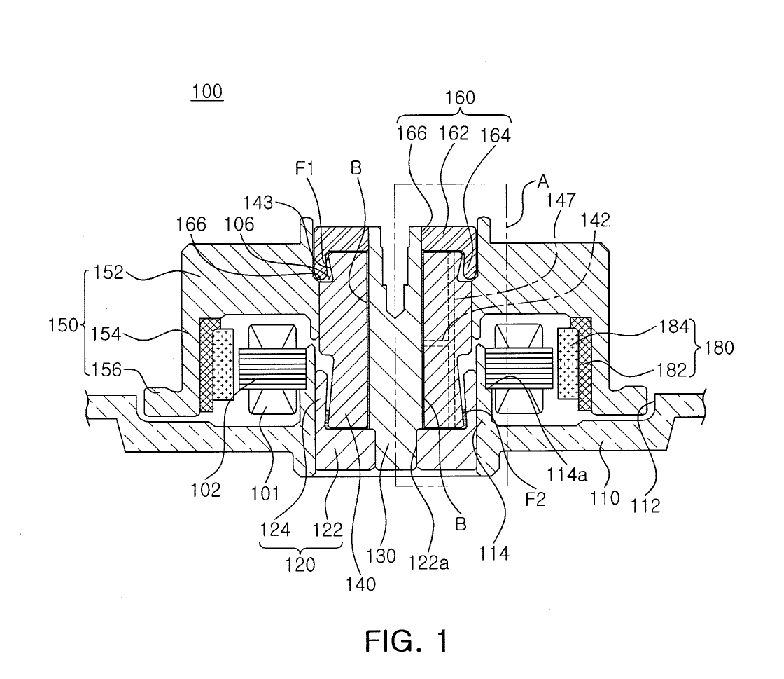

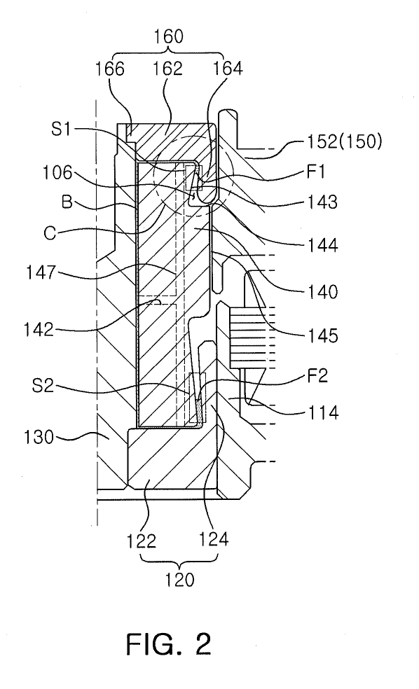

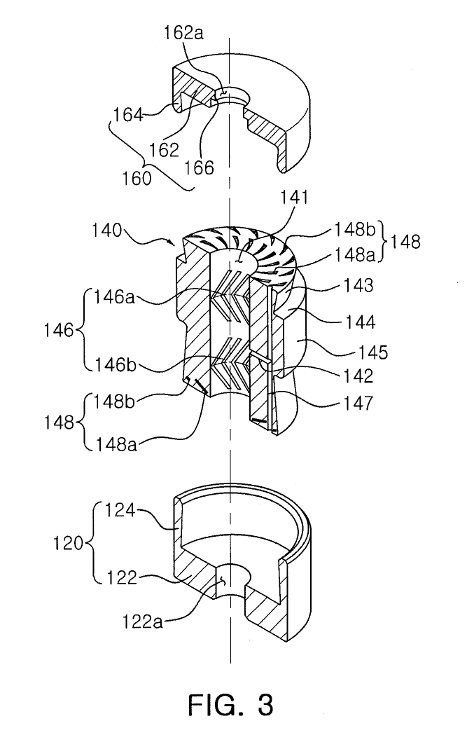

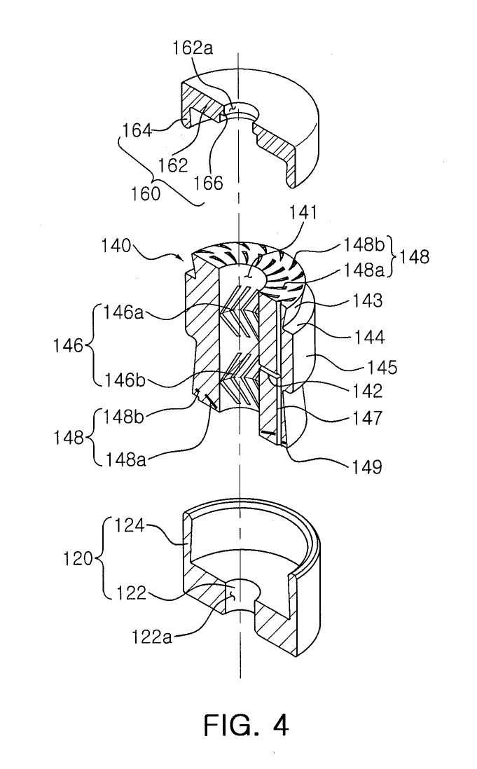

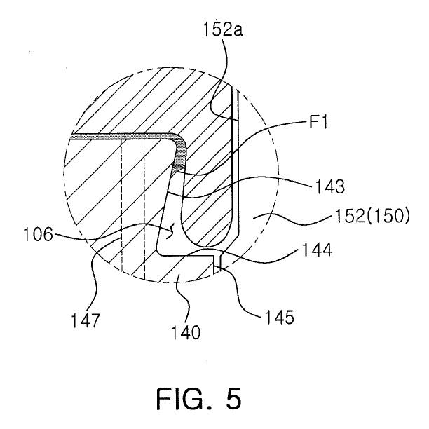

FIG. 1 is a schematic cross-sectional view of a spindle motor 100 according to an embodiment of the present invention. FIG. 2 is an enlarged cross-sectional view of a portion ‘A’ of FIG. 1. FIGS. 3 and 4 are partial exploded perspective views illustrating a sleeve 140, an upper thrust member 160, and a lower thrust member 120 of FIG. 1. FIG. 5 is a diagram for explaining an operation of the spindle motor 100 of FIG. 1, according to an embodiment of the present invention.

Referring to FIGS. 1 through 5, the spindle motor 100 may include a base member 110, the lower thrust member 120, a shaft 130, the sleeve 140, a rotor hub 150, and the upper thrust member 160.

The base member 110 may include a mounting groove 112 so that the base member 110 and the rotor hub 150 may form together a predetermined space. In addition, the base member 110 may include a coupling portion 114 that extends upwards in an axial direction and has an outer circumferential surface on which a stator core 102 is installed.

An accommodation surface 114a for accommodating the stator core 102 installed thereon may be formed on the outer circumferential surface of the coupling portion 114. In addition, the stator core 102 accommodated on the coupling portion 114 may be disposed above the mounting groove 112 of the base member 110.

The lower thrust member 120 may be fixed to the base member 110. That is, the lower thrust member 120 may be inserted into the coupling portion 114. In more detail, the lower thrust member 120 and the coupling portion 114 may be installed so that an outer circumferential surface of the lower thrust member 120 may be adhered to an inner circumferential surface of the coupling portion 114.

The lower thrust member 120 may include a disk portion 122 having an inner surface fixed to the shaft 130 and an outer surface fixed to the base member 110, and an extension portion 124 that extends upwards from the disk portion 122 in the axial direction.

The lower thrust member 120 may have a cup shape with a cavity. That is, the lower thrust member 120 may have a cross section having a ‘L’ shape.

An installing hole 122a for installing the shaft 130 therein may be formed in the disk portion 122. The shaft 130 may be inserted into the installing hole 122a.

In this case, terms with respect to directions will be first defined. As viewed in FIG. 1, an axial direction refers to a vertical direction, that is, a direction from a lower portion of the shaft 130 towards an upper portion thereof or a direction from the upper portion of the shaft 130 towards the lower portion thereof. A radial direction refers to a direction towards an outer circumferential surface of the rotor hub 150 from the center of the shaft 130 or a direction towards the center of the shaft 130 from the outer circumferential surface of the rotor hub 150. A circumferential direction refers to a direction along an outer circumferential surface of the rotor hub 150.

The lower thrust member 120 and the base member 110 are included together in a fix member, that is, a stator.

An outer surface of the lower thrust member 120 may be adhered to an inner surface of the base member 110 by adhesives and/or by using a welding method. In other words, the outer surface of the lower thrust member 120 is fixed and adhered to the inner surface of the coupling portion 114 of the base member 110.

Thrust dynamic-pressure grooves 148 for generating a fluid dynamic-pressure may be formed in at least one of a top surface of the lower thrust member 120 and a bottom surface of the sleeve 140, which will be described below in detail with reference to FIGS. 3 and 4.

In addition, the lower thrust member 120 may also serve as a sealing member for preventing lubricating fluid from leaking, which will be described below in detail with reference to FIGS. 2 through 4.

The shaft 130 may be fixed to at least one of the lower thrust member 120 and the base member 110. That is, a lower end portion of the shaft 130 may be inserted into the installing hole 122a formed in the disk portion 122 of the lower thrust member 120.

The lower end portion of the shaft 130 may be adhered to an inner surface of the disk portion 122 by adhesives and/or by using a welding method. Thus, the shaft 130 may be fixedly installed.

According to the present embodiment, the shaft 130 is fixed to the lower thrust member 120, but the present invention is not limited thereto. That is, the shaft 130 may be fixed to the base member 110.

The shaft 130, the lower thrust member 120, and the base member 110 are included together in a fix member, that is, a stator.

A coupler for fixing a cover member (not shown) to a top surface of the shaft 130 may be disposed on the top surface of the shaft 130 and may be, for example, a screw portion to which a screw is coupled.

The sleeve 140 may be installed to be rotatable with the shaft 130. To this end, the sleeve 140 may include a through hole 141 into which the shaft 130 is inserted. When the sleeve 140 is installed to be rotatable with the shaft 130, an inner circumferential surface of the sleeve 140 is spaced apart from an outer circumferential surface of the shaft 130 by a predetermined interval, thereby forming a bearing gap B. Lubricating fluids are filled in the bearing gap B therebetween.

An inclination portion 143 may be formed on an upper end portion of the sleeve 140. An external diameter of an upper portion of the inclination portion 143 may be greater than that of a lower portion of the inclination portion 143 so that the inclination portion 143 and the upper thrust member 160 may form together a liquid-vapor interface.

In other words, the inclination portion 143 of which the external diameter of the upper portion is greater than that of the lower portion may be formed on the upper end portion of the sleeve 140 so as to form a first liquid-vapor interface F1 in a space between an outer circumferential surface of the sleeve 140 and an inner circumferential surface of the upper thrust member 160.

A step surface 144 for forming a sealing groove 106 may be formed on the upper end portion of the sleeve 140 to have a step difference with the top surface of the sleeve 140. The step surface 144 will be described below in detail.

The rotor hub 150 may be adhered to the outer circumferential surface of the sleeve 140. That is, a portion of the sleeve 140, below the step surface 144, may have a shape corresponding to the inner surface of the rotor hub 150 so that the rotor hub 150 may be fixed to the sleeve 140. That is, an adhering surface 145 may be formed on the outer circumferential surface of the sleeve 140. In this case, the sleeve 140 and the rotor hub 150 may be integrated together. When the sleeve 140 and the rotor hub 150 are integrated together, the sleeve 140 and the rotor hub 150 may be provided as a single member, thereby reducing the number of components and simplifying assembling of the spindle motor 100.

A lower end portion of the outer circumferential surface of the sleeve 140 may taper upwards in an inner diameter direction so that it may form a liquid-vapor interface together with the lower end portion of the extension portion 124 of the lower thrust member 120.

That is, the lower end portion of the sleeve 140 may taper upwards in an inner diameter direction so as to form a second liquid-vapor interface F2 in a space between the outer circumferential surface of the sleeve 140 and the extension portion 124 of the lower thrust member 120.

Since the second liquid-vapor interface F2 is formed in the space between the lower end portion of the sleeve 140 and the extension portion 124, the lubricating fluids filled in the bearing gap B may form the first liquid-vapor interface F1 and the second liquid-vapor interface F2.

Dynamic-pressure grooves 146 may be formed in an inner circumferential surface of the sleeve 140 and may generate a fluid dynamic-pressure by using the lubricating fluids filled in the bearing gap B as a medium during the rotation of the sleeve 140. That is, the dynamic-pressure grooves 146 may include upper and lower dynamic-pressure grooves 146a and 146b, as shown in FIGS. 3 and 4.

However, the dynamic-pressure grooves 146 are not limited to being formed in the inner surface of the sleeve 140 and may also be formed in the outer circumferential surface of the shaft 130. In addition, the dynamic-pressure grooves 146 may each have various shapes such as a herringbone shape, a spiral shape, or a screw shape.

The sleeve 140 may further include a circulation hole 147 that is formed from a top surface of the sleeve 140 to a bottom surface of the sleeve 140. The circulation hole 147 may allow for discharge of vapors contained in the lubricating fluids filled in the bearing gap B therethrough, and the lubricating fluids may be easily circulated through the circulation hole 147.

The sleeve 140 may further include a connection hole 142 through which the circulation hole 147 and the bearing gap B that is formed by the sleeve 140 and the shaft 130 are connected. The connection hole 142 may effectively use a fluid dynamic-pressure bearing assembly although a pumping direction of the dynamic-pressure grooves 146 is changed. That is, the pumping direction of the dynamic-pressure grooves 146 may be changed so as to increase design diversity of the spindle motor 100.

The rotor hub 150 may be coupled to the sleeve 140 so that the rotor hub 150 and the sleeve 140 may rotate together.

The rotor hub 150 may include a rotor hub body 152 in which an insertion portion 152a into which the upper thrust member 160 is inserted is formed, an installation portion 154 that extends from an edge of the rotor hub body 152 and has an inner surface on which a magnet assembly 180 is installed, and an extension portion 156 that extends in an outer direction from an end of the installation portion 154.

A lower end portion of an inner surface of the rotor hub body 152 may be coupled to an outer surface of the sleeve 140. That is, the lower end portion of the inner surface of the rotor hub body 152 may be coupled to the adhering surface 145 of the sleeve 140 by adhesives and/or by using a welding method.

Thus, during the rotation of the rotor hub 150, the sleeve 140 and the rotor hub 150 may rotate together.

In addition, the installation portion 154 may extend downwards in the axial direction from the rotor hub body 152. In addition, the magnet assembly 180 may be fixed to an inner surface of the installation portion 154.

The magnet assembly 180 may include a yoke 182 that is fixed to the inner surface of the installation portion 154 and a magnet 184 that is installed on an inner circumferential surface of the yoke 182.

The yoke 182 may serve to allow a magnetic field from the magnet 184 to be directed towards the stator core 102 so as to increase a magnetic flux density of the magnetic field. The yoke 182 may have a circular ring shape and may have one bent end portion so as to increase the magnetic flux density of the magnetic field generated from the magnet 184.

The magnet 184 may have a circular ring shape and may be a permanent magnet of which N and S poles are alternately magnetized in the circumferential direction so as to generate a magnetic field with a constant intensity.

The magnet 184 may face a front end of the stator core 102 around which a coil 101 is wound and may generate a driving force so that the rotor hub 150 may rotate by an electromagnetic interaction between the magnet 184 and the stator core 102 around which the coil 101 is wound.

That is, when power is supplied to the coil 101, a driving force may be generated so that the rotor hub 150 may rotate by an electromagnetic interaction between the stator core 102 around which the coil 101 is wound and the magnet 184 facing the stator core 102, and thus the rotor hub 150 and the sleeve 140 may rotate together.

The upper thrust member 160 may be fixed to an upper end portion of the shaft 130. The upper thrust member 160 and the sleeve 140 may form together a liquid-vapor interface. In addition, a bottom surface of the upper thrust member 160 may be supported by a top surface of the shaft 130 so as to increase a coupling strength with the shaft 130. The upper thrust member 160 may include a platform portion 166 of which a top surface is pressured by a cover member (not shown).

The upper thrust member 160 may include a body 162 of which an inner surface is coupled to the shaft 130, a protrusion portion 164 that extends from the body 162 and forms a liquid-vapor interface together with the inclination portion 143, and the platform portion 166 that extends inwards in the radial direction from the inner surface of the body 162.

The protrusion portion 164 may extend downwards in the axial direction from the body 162. An inner surface of the protrusion portion 164 may face the inclination portion 143.

The protrusion portion 164 may extend from the body 162 to be in parallel to the shaft 130.

The upper thrust member 160 may be inserted into a space that is formed by an upper end portion of the outer circumferential surface of the shaft 130, an outer surface of the sleeve 140, and the inner surface of the rotor hub 150.

The upper thrust member 160 may be a fixed member that is fixed together with the base member 110, the lower thrust member 120, and the shaft 130 and is included in a stator.

Since the upper thrust member 160 is fixed to the shaft 130 and the sleeve 140 and the rotor hub 150 rotate together, the first liquid-vapor interface F1 formed in a space between the inclination portion 143 of the sleeve 140 and the protrusion portion 164 may be inclined towards the inclination portion 143 of the sleeve 140 during the rotation of the sleeve 140, as shown in FIG. 5.

That is, the first liquid-vapor interface F1 may be inclined towards the outer circumferential surface of the sleeve 140, thereby preventing lubricating fluids from being dispersed due to a centrifugal force.

In addition, an outer circumferential surface of the upper thrust member 160, and the inner surface of the rotor hub 150 facing the outer circumferential surface of the upper thrust member 160, may form a labyrinth seal. That is, an outer surface of the upper thrust member 160 and the inner surface of the rotor hub body 152 may be spaced apart from each other by a predetermined interval and may form the labyrinth seal so as to prevent air containing vaporized lubricating fluids from moving outside.

Thus, the air containing vaporized lubricating fluids may be prevented from moving outside, thereby preventing a reduction in the lubricating fluids.

The outer circumferential surface of the upper thrust member 160 and the inner surface of the rotor hub body 152 may form a gap of a width of 0.3 mm or less.

In addition, the platform portion 166 maybe pressurized by a cover member (not shown) when the cover member is fixed to the shaft 130 by a fastening part, that is, a screw, thereby increasing a coupling strength between the upper thrust member 160 and the shaft 130.

A bottom surface of the platform portion 166 may be supported by the shaft 130 and a top surface of the platform portion 166 maybe pressurized by the cover member so that the upper thrust member 160 may be stably fixed to the shaft 130.

Thrust dynamic-pressure grooves for generating a thrust dynamic pressure may be formed in at least one of the bottom surface of the upper thrust member 160 and the top surface of the sleeve 140 that faces the bottom surface of the upper thrust member 160. According to the present embodiment, the thrust dynamic-pressure grooves may include any type of thrust dynamic-pressure grooves that are formed in a radial direction when the sleeve 140 does not include the circulation hole 147. For example, a single thrust dynamic-pressure groove or two or more thrust dynamic-pressure grooves maybe formed in a radius direction. Meanwhile, according to the present embodiment, when the sleeve 140 includes the circulation hole 147, the thrust dynamic-pressure grooves may refer to only thrust dynamic-pressure grooves 148a formed inwardly, in the radial direction, of top and lower surfaces of the sleeve 140 based on the circulation hole 147.

The upper thrust member 160 may function as a sealing member that prevents the lubricating fluids filled in the bearing gap B from leaking upwards.

Since an interval between the upper thrust member 160 and the rotor hub 150 is relatively reduced, air containing vaporized lubricating fluids may be suppressed from moving outside and so a reduction in the lubricating fluids filled in an upper portion of the bearing gap B may be prevented.

Since the sleeve 140, a rotation member, among the rotation member (i.e., a sleeve) and a fix member (i.e., upper and lower thrust members) which form liquid-vapor interfaces, that is, the first liquid-vapor interface F1 and the second liquid-vapor interface F2 therebetween, is disposed inwardly in the radial direction, as compared to the fix member, thereby preventing lubricating fluids from being dispersed due to a centrifugal force.

Hereinafter, a structure of sealing potions S1 and S2 that are features of the present embodiment will be described in detail with reference to FIGS. 2 through 4.

Referring to FIGS. 2 through 4, a pair of sealing portions S1 and S2 may be vertically disposed. That is, the sleeve 140 may be disposed above the lower thrust member 120 so that the sleeve 140 together with the lower thrust member 120 forms the second liquid-vapor interface F2 of the lubricating fluids to thus form the lower sealing portion S2. The sleeve 140 may be disposed below the upper thrust member 160 so that the sleeve 140 together with the upper thrust member 160 forms the first liquid-vapor interface F1 of the lubricating fluids to thus form the lower sealing portion S1.

According to the present embodiment, a volume of sealed lubricating fluids of either of the upper sealing portion S1 and the lower sealing portion S2 may be greater than the other. In the upper and lower sealing portions S1 and S2, the lubricating fluids and air may be intersected, as indicated by a box shown in FIG. 2, and the upper and lower sealing portions S1 and S2 may refer to portions in which fluids are sealed by capillary action.

According to the present embodiment, lubricating fluids may be pumped towards a sealing portion with a great sealing volume from among the upper and lower sealing portions S1 and S2, thereby preventing lubricating fluids from leaking during an operation of the spindle motor 100.

Thus, a thrust dynamic-pressure groove positioned in a sealing portion with a small sealing volume from among the upper and lower sealing portions S1 and S2 may have a greater pumping force than that of a thrust dynamic-pressure groove positioned in the other sealing portion. That is, lubricating fluids of a thrust dynamic-pressure groove having a relatively great pumping force may be pumped towards a thrust dynamic-pressure groove having a relatively small pumping force so that lubricating fluids may be stored in a sealing portion with a relatively great sealing volume from among the upper and lower sealing portions S1 and S2. In this case, the thrust dynamic-pressures groove may each have various shapes such as a herringbone shape, a spiral shape, or a screw shape.

To this end, a thrust dynamic-pressure groove positioned in a sealing portion with a small sealing volume from among the upper and lower sealing portions S1 and S2 may be formed to have a smaller depth than a thrust dynamic-pressure groove positioned in the other sealing portion. When a thrust dynamic-pressure groove has a relatively small depth, the thrust dynamic-pressure groove may have a relatively great pumping force, and thus the thrust dynamic-pressure groove may pump lubricating fluids towards a sealing portion with a great sealing volume.

In addition, an axial interval between the sleeve 140 and a thrust member positioned in a sealing portion with a small sealing volume from among the upper and lower sealing portions S1 and S2 may be smaller than an axial interval between the sleeve 140 and a thrust member positioned in the other sealing portion. That is, as an interval between a rotation member and a member adjacent to the rotation member is relatively recued, a pumping force due to a dynamic-pressure groove may be further increased. Thus, lubricating fluids may be pumped towards a sealing portion with a relatively great sealing volume by adjusting an interval between a thrust member and the sleeve 140.

Meanwhile, when the sleeve 140 includes the circulation hole 147 that is formed from the top surface of the sleeve 140 to the bottom surface of the sleeve 140, sleeves or thrust members for pumping lubricating fluids towards a sealing portion with a great sealing volume may be configured to have different structures.

That is, when the circulation hole 147 is used, the thrust dynamic-pressure grooves 148 may include the thrust dynamic-pressure grooves 148a formed inwardly, in a radial direction, of top and lower surfaces of the sleeve 140 based on the circulation hole 147, and auxiliary thrust dynamic-pressure grooves 148b formed outwardly, in a radial direction, of top and lower surfaces of the sleeve 140 based on the circulation hole 147.

That is, upper and lower pumping forces of lubricating fluids may be different by virtue of the auxiliary thrust dynamic-pressure grooves 148b formed outwardly, in the radial direction, of top and lower surfaces of the sleeve 140 based on the circulation hole 147. The thrust dynamic-pressure grooves 148a formed inwardly, in the radial direction, of top and lower surfaces of the sleeve 140 may generate a levitation force of the rotation member or may circulate lubricating fluids, instead of generating a difference in the upper and lower pumping forces of the lubricating fluids. However, the present invention is not limited thereto and may be modified in various ways.

Thus, the auxiliary thrust dynamic-pressure grooves 148b positioned in a sealing portion with a small sealing volume from among the upper sealing portion S1 and the lower sealing portion S2 may each have a greater pumping force than a thrust dynamic-pressure groove positioned in the other sealing portion. Accordingly, the lubricating fluids may be pumped towards a sealing portion with a great sealing volume and may be stored in the sealing portion.

The auxiliary thrust dynamic-pressure grooves 148b positioned in a sealing portion with a small sealing volume from among the upper sealing portion S1 and the lower sealing portion S2 may each have a smaller depth than that of a thrust dynamic-pressure groove positioned in the other sealing portion. Thus, the lubricating fluids may be pumped towards a sealing portion with a great sealing volume.

Furthermore, with regard to a portion positioned outwardly, in the radial direction, of top and lower surfaces of the sleeve 140 based on the circulation hole 147, an axial interval between the sleeve 140 and a thrust member positioned in a sealing portion with a small sealing volume from among the upper and lower sealing portions S1 and S2 may be smaller than an axial interval between the sleeve 140 and a thrust member positioned in the other sealing portion. Thus, the lubricating fluids may be pumped towards a sealing portion with a great sealing volume.

In detail, referring to FIG. 4, when it is assumed that the lower sealing portion S2 that is positioned at a lower portion in an axial direction has a great sealing volume, an end portion of the sleeve 140, positioned at the lower sealing portion S2 with a great sealing volume from among the upper sealing portion S1 and the lower sealing portion S2, may include a step portion 149 that is formed in an outer diameter direction based on the circulation hole 147, and thus an axial interval between the lower thrust member 120 and the sleeve 140 may be greater than an axial interval between the upper thrust member 160 and the sleeve 140. Accordingly, the auxiliary thrust dynamic-pressure grooves 148b that are positioned at an upper portion may have a relatively great pumping force, and thus lubricating fluids may be pumped towards the lower sealing portion S2.

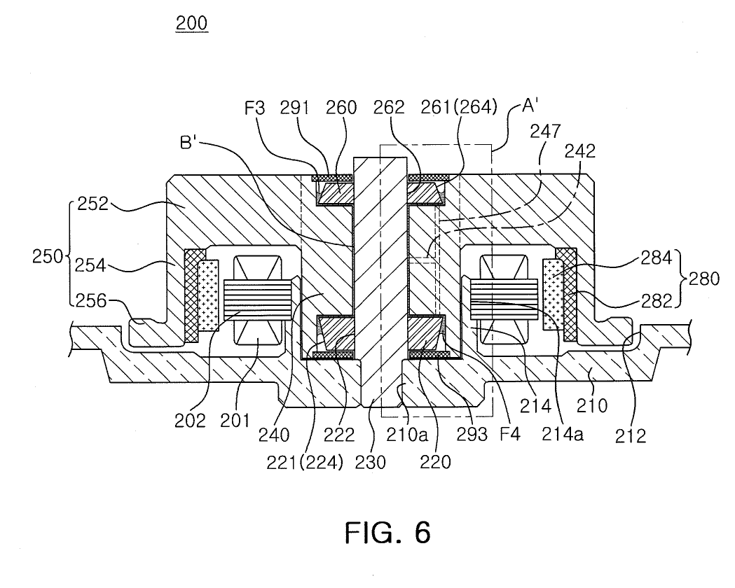

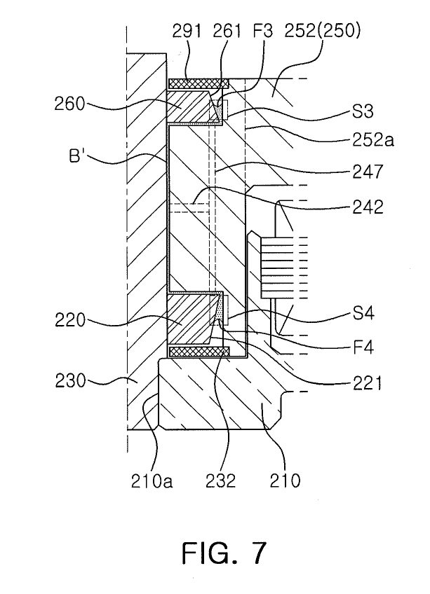

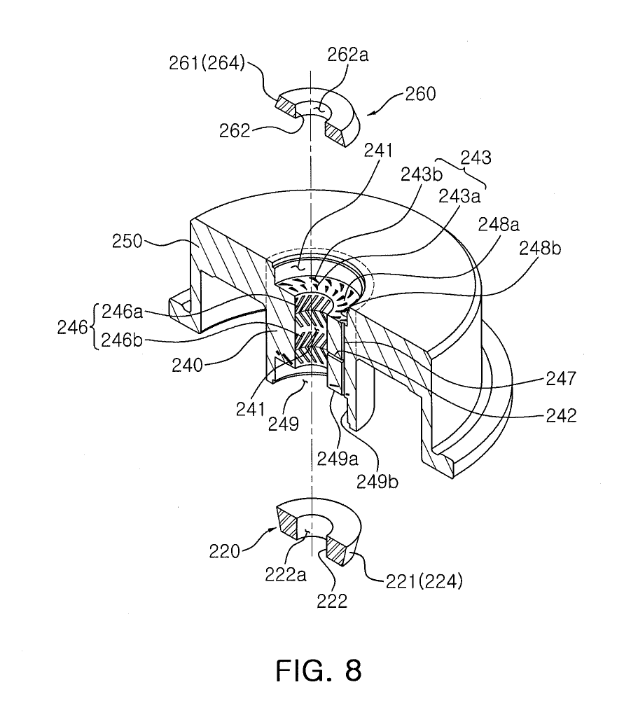

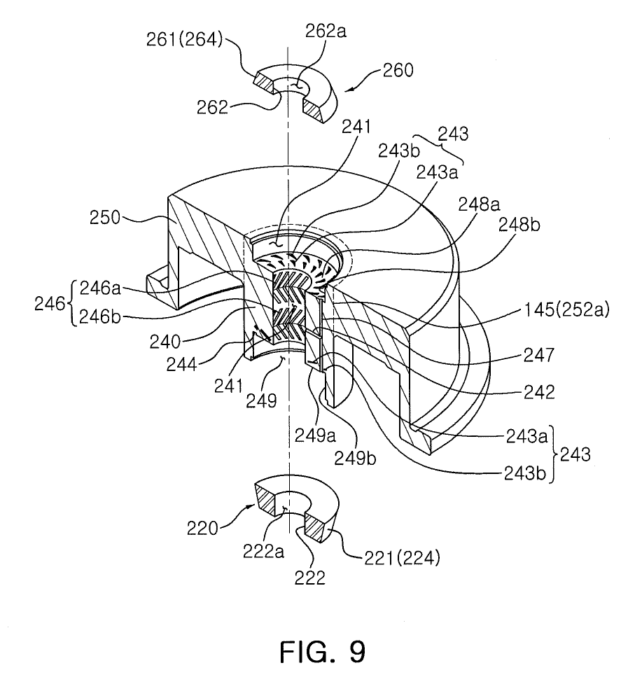

FIG. 6 is a schematic cross-sectional view of a spindle motor 200 according to another embodiment of the present invention. FIG. 7 is an enlarged cross-sectional view of a portion ‘A′’ of FIG. 6. FIGS. 8 and 9 are partial exploded perspective views illustrating a sleeve 240, an upper thrust member 260, and a lower thrust member 220 of FIG. 6.

Referring to FIGS. 6 through 9, the spindle motor 200 may include a base member 210, the lower thrust member 220, a shaft 230, the sleeve 240, a rotor hub 250, and the upper thrust member 260.

In this case, terms with respect to directions will be first defined. As viewed in FIG. 6, an axial direction refers to a vertical direction, that is, a direction from a lower portion of the shaft 230 towards an upper portion of the shaft 230 or a direction from the upper portion of the shaft 230 towards the lower portion of the shaft 230. A radial direction refers to a direction towards an outer circumferential surface of the rotor hub 250 from the center of the shaft 230 or a direction towards the center of the shaft 230 from the outer circumferential surface of the rotor hub 250. A circumferential direction refers to a direction along an outer circumferential surface of the rotor hub 250.

The base member 210 may include a mounting groove 212 so that the base member 210 and the rotor hub 250 may form together a predetermined space. In addition, the base member 210 may include a coupling portion 214 that extends upwards in the axial direction and has an outer circumferential surface on which a stator core 202 is installed.

An accommodation surface 214a for accommodating the stator core 202 installed thereon may be formed on the outer circumferential surface of the coupling portion 214. In addition, the stator core 202 accommodated on the coupling portion 214 may be disposed above the mounting groove 212 of the base member 210.

The shaft 230 may be fixed to the base member 210. That is, a lower end portion of the shaft 230 may be inserted into an installing hole 210a formed in the base member 210. In addition, the lower end portion of the shaft 230 may be adhered to the inner surface of the base member 210 by adhesives and/or by using a welding method. Thus, the shaft 230 may be fixedly installed.

The shaft 230, the upper and lower thrust members 260 and 220 and the base member 210 that will be described below, are included together in a fix member, that is, a stator.

A coupler for fixing a cover member (not shown) to a top surface of the shaft 230 may be disposed on the top surface of the shaft 230 and may be, for example, a screw portion to which a screw is coupled.

The sleeve 240 may be installed to be rotatable with the shaft 230. To this end, the sleeve 240 may include a bearing unit formed with a through hole 241 into which the shaft 230 is inserted. When the sleeve 240 is installed to be rotatable with the shaft 230, an inner circumferential surface of the sleeve 240 is spaced apart from an outer circumferential surface of the shaft 230 by a predetermined interval, thereby forming a bearing gap B′. Lubricating fluids may be filled in the bearing gap B′.

In addition, the sleeve 240 may include upper and lower groove portions 248 and 249 that respectively accommodate the upper and lower thrust members 260 and 220 that will be described below. The upper and lower groove portions 248 and 249 may be formed by upper and lower groove bottom surfaces 248a and 249a, and upper and lower groove lateral walls 248b and 249b, respectively. According to the present embodiment, the term ‘groove bottom surface’ refers to a surface that is perpendicular to the axial direction in the upper and lower groove portions 248 and 249. The term ‘groove lateral wall’ refers to a surface that is formed in parallel to the axial direction.

Dynamic-pressure grooves 246 may be formed in an inner circumferential surface of the sleeve 240 and may generate a fluid dynamic-pressure by using lubricating fluids filled in the bearing gap B′ as a medium during rotation of the sleeve 240. That is, the dynamic-pressure grooves 246 may include upper and lower dynamic-pressure grooves 246a and 246b, as shown in FIGS. 8 and 9.

However, the dynamic-pressure grooves 246 are not limited to being formed in the inner surface of the sleeve 240 and may also be formed in the outer circumferential surface of the shaft 230. In addition, the dynamic-pressure grooves 246 may each have various shapes such as a herringbone shape, a spiral shape, or a screw shape.

The sleeve 240 may further include a circulation hole 247 that is formed from the upper groove portion 248 of the sleeve 240 to the lower groove portion 249 of the sleeve 240. The circulation hole 247 may discharge vapors contained in the lubricating fluids filled in the bearing gap B′ therethrough and may easily circulate the lubricating fluids.

The sleeve 240 may further include a connection hole 242 through which the circulation hole 247 and the bearing gap B′ that is formed by the sleeve 240 and the shaft 230 are connected. The connection hole 242 may effectively use a fluid dynamic-pressure bearing assembly although a pumping direction of the dynamic-pressure grooves 246 is changed. That is, the pumping direction of the dynamic-pressure grooves 246 may be changed so as to increase design diversity the spindle motor 200.

The rotor hub 250 may be coupled to the sleeve 240 so that rotor hub 250 and the sleeve 240 may rotate together.

The rotor hub 250 may include a rotor hub body 252 in which an insertion portion 252a into which the sleeve 240 is inserted is formed, an installation portion 254 that extends from an edge of the rotor hub body 252 and has an inner surface on which a magnet assembly 280 is installed, and an extension portion 256 that extends outwards in the radial direction from an end of the installation portion 254.

A lower end portion of an inner surface of the rotor hub body 252 may be coupled to an outer surface of the sleeve 240. That is, the lower end portion of the inner surface of the rotor hub body 252 may be coupled to an adhering surface 245 of the sleeve 240 by adhesives and/or by using a welding method.

Thus, during the rotation of the rotor hub 250, the sleeve 240 and the rotor hub 250 may rotate together.

In addition, the installation portion 254 extends downwards in the axial direction from the rotor hub body 252. In addition, the magnet assembly 280 may be fixed to an inner surface of the installation portion 254.

The magnet assembly 280 may include a yoke 282 that is fixed to the inner surface of the installation portion 254 and a magnet 284 that is installed on an inner circumferential surface of the yoke 282.

The yoke 282 may allow a magnetic field from the magnet 284 to be directed towards the stator core 202 so as to increase a magnetic flux density of the magnetic field. The yoke 282 may have a circular ring shape and may have one bent end portion so as to increase the magnetic flux density of the magnetic field from the magnet 284.

The magnet 284 may have a circular ring shape and maybe a permanent magnet of which N and S poles are alternately magnetized in the circumferential direction so as to generate a magnetic field with a constant intensity.

The magnet 284 may face a front end of the stator core 202 around which a coil 201 is wound and may generate a driving force so that the rotor hub 250 may rotate by an electromagnetic interaction between the magnet 284 and the stator core 202 around which the coil 201 is wound.

That is, when power is supplied to the coil 201, a driving force is generated so that the rotor hub 250 may rotate by an electromagnetic interaction between the stator core 202 around which the coil 201 is wound and the magnet 284 facing the stator core 202, and thus the rotor hub 250 and the sleeve 240 may rotate together.

The upper thrust member 260 is fixed to an upper end portion of the shaft 230. The upper thrust member 260 together with the upper groove lateral wall 248b of the sleeve 240 forms an upper liquid-vapor interface F3. The upper thrust member 260 may include an inner lateral surface 262 coupled to the shaft 230 and an outer lateral surface 264 that is formed along an outer circumferential surface of the upper thrust member 260, wherein the outer lateral surface 264 together with the upper groove lateral wall 248b forms a liquid-vapor interface. In this case, the outer lateral surface 264 may be configured as an upper inclination portion 261 of which an external diameter of an upper portion is smaller than that of a lower portion.

Thrust dynamic-pressure grooves for generating a thrust dynamic pressure may be formed in at least one of a bottom surface of the upper thrust member 260 and the upper grooved bottom surface 248a of the sleeve 240, facing the bottom surface of the upper thrust member 260. According to the present embodiment, the thrust dynamic-pressure grooves may include any type of thrust dynamic-pressure groove that is formed in the radial direction when the sleeve 240 does not include the circulation hole 247. For example, a single thrust dynamic-pressure groove or two or more thrust dynamic-pressure grooves may be formed. Meanwhile, according to the present embodiment, when the sleeve 240 includes the circulation hole 247, the thrust dynamic-pressure grooves may refer to only thrust dynamic-pressure grooves 243a inwardly, in a radial direction, of top and lower surfaces of the sleeve 240 based on the circulation hole 247.

In addition, an upper cap 291 serving as a sealing member may be formed above the upper thrust member 260 so as to prevent the lubricating fluids filled in the bearing gap B′ from leaking upward. The upper cap 291 may cover an axial upper portion of the upper groove portion 248 so as to prevent lubricating fluids from being dispersed and leaking through the upper groove portion 248. That is, the upper cap 291 may be fixed to the upper groove lateral wall 248b of the sleeve 240 by using a fixing method or by adhesives. In addition, an interval between the shaft 230 and a shaft hole of the upper cap 291 by which the shaft 230 protrudes upwards, may be reduced. Thus, the air containing vaporized lubricating fluids may be prevented from moving outside, thereby preventing a reduction in lubricating fluids filled in an upper portion of the bearing gap B′.

The lower thrust member 220 maybe fixed to a lower end portion of the shaft 230. The lower thrust member 220 together with the lower groove lateral wall 249b of the sleeve 240 forms a lower liquid-vapor interface F4. The lower thrust member 220 may include an inner lateral surface 222 coupled to the shaft 230 and an outer lateral surface 224 that is formed along an outer circumferential surface of the lower thrust member 220, wherein the outer lateral surface 224 together with the lower groove lateral wall 249b forms a liquid-vapor interface. In this case, the outer lateral surface 224 maybe configured as a lower inclination portion 221 of which an external diameter of a lower portion is smaller than that of an upper portion.

Thrust dynamic-pressure grooves for generating a thrust dynamic pressure maybe formed in at least one of a top surface of the lower thrust member 220 and the lower grooved bottom surface 249a of the sleeve 240 facing the top surface of the lower thrust member 220. According to the present embodiment, the thrust dynamic-pressure grooves may include any type of thrust dynamic-pressure grooves that are formed in the radial direction when the sleeve 240 does not include the circulation hole 247. For example, a single thrust dynamic-pressure groove or two or more thrust dynamic-pressure grooves may be formed. Meanwhile, according to the present embodiment, when the sleeve 240 includes the circulation hole 247, the thrust dynamic-pressure groove may refer to only the thrust dynamic-pressure grooves 243a formed inwardly, in a radial direction, of top and lower surfaces of the sleeve 240 based on the circulation portion 247.

In addition, a lower cap 293 serving as a sealing member may be formed below the lower thrust member 220 so as to prevent the lubricating fluids filled in the bearing gap B′ from leaking downward. The lower cap 293 may cover an axial lower portion of the lower groove portion 249 so as to prevent lubricating fluids from being dispersed and leaking through the lower groove portion 249. That is, the lower cap 293 may be fixed to the lower groove lateral wall 249b of the sleeve 240 by using a fixing method or by adhesives. In addition, an interval between the shaft 230 and a shaft hole of the lower cap 293 by which the shaft 230 protrudes downwards, may be reduced. Thus, the air containing vaporized lubricating fluids may be prevented from moving outside, thereby preventing a reduction in lubricating fluids filled in an upper portion of the bearing gap B′.

Hereinafter, a structure of upper and lower sealing potions S3 and S4 having features of the present embodiment will be described in detail with reference to FIGS. 7 through 9.

Referring to FIGS. 7 through 9, a pair of upper and lower sealing portions S3 and S4 may be vertically disposed. That is, the sleeve 240 includes the upper groove portion 248 and the lower groove portion 249 that are formed in upper and lower portions thereof, respectively. The upper groove portion 248 and the lower groove portion 249 may accommodate the upper thrust member 260 and the lower thrust member 220, respectively, and may form the upper and lower sealing portions S3 and S4.

That is, the upper liquid-vapor interface F3 of lubricating fluids may be formed between the outer lateral surface 264 of the upper thrust member 260 and the upper groove lateral wall 248b of the upper groove portion 248, and thus, the upper sealing portion S3 maybe formed. In the same manner, the lower liquid-vapor interface F4 of lubricating fluids may be formed between the outer lateral surface 224 of the lower thrust member 220 and the lower groove lateral wall 249b of the lower groove portion 249, and the lower sealing portion S4 may be formed.

In this case, according to the present embodiment, a sealing volume of lubricating fluids of either of the upper sealing portion S3 and the lower sealing portion S4 may be greater than the other. The upper and lower portions S3 and S4 may have intersections of the lubricating fluids with air, as indicated by a box shown in FIG. 7 and refer to portions in which fluids are sealed by capillary action.

According to the present embodiment, lubricating fluids may be pumped towards a sealing portion with a relatively great sealing volume from among the upper and lower portions S3 and S4, thereby preventing lubricating fluids from leaking during an operation of the spindle motor 200.

Thus, a thrust dynamic-pressure groove positioned in a sealing portion with a small sealing volume from among the upper sealing portion S3 and the lower sealing portion S4 may have a greater pumping force than that of a thrust dynamic-pressure groove positioned in the other sealing portion. That is, lubricating fluids of a thrust dynamic-pressure groove having a relatively great pumping force may be pumped towards a thrust dynamic-pressure groove having a relatively small pumping force so that lubricating fluids may be stored in a sealing portion with a great sealing portion from among the upper sealing portion S3 and the lower sealing portion S4. In this case, the thrust dynamic-pressure groove may each have various shapes such as a herringbone shape, a spiral shape, or a screw shape.

To this end, a thrust dynamic-pressure groove positioned in a sealing portion with a small sealing volume from among the upper sealing portion S3 and the lower sealing portion S4 may be formed to have a smaller depth than a thrust dynamic-pressure groove positioned in the other sealing portion. When a thrust dynamic-pressure groove has a relatively small depth, the thrust dynamic-pressure groove may have a great pumping force, and thus the thrust dynamic-pressure groove may pump lubricating fluids towards a sealing portion with a great sealing volume.

In addition, an axial interval between a grooved bottom surface of the sleeve 240 and a thrust member positioned in a sealing portion with a small sealing volume from among the upper sealing portion S3 and the lower sealing portion S4 may be smaller than an axial interval between the grooved bottom surface of the sleeve 240 and a thrust member positioned in the other sealing portion. That is, as an interval between a rotation member and a member adjacent to the rotation member is recued, a pumping force due to a dynamic-pressure groove may be further increased. Thus, lubricating fluids may be pumped towards a sealing portion with a great sealing volume by adjusting an interval between a grooved bottom surface of the sleeve 240 and a thrust member.

When the sleeve 240 includes the circulation hole 247 that is formed from the upper groove portion 248 of the sleeve 240 and the lower groove portion 249 of the sleeve 240, sleeves or thrust members for pumping lubricating fluids towards a sealing portion with a great sealing volume may be configured to have different structures.

That is, when the circulation hole 247 is used, thrust dynamic-pressure grooves 243 may include the thrust dynamic-pressure grooves 243a that are formed in the upper and lower groove portions 248 and 249, that is, formed inwardly, in a radial direction, of top and lower surfaces of the sleeve 240 based on the circulation hole 247; and auxiliary thrust dynamic-pressure grooves 243b formed in the upper and lower groove portions 248 and 249, that is, formed outwardly, in the radial direction, of top and lower surfaces of the sleeve 240 based on the circulation hole 247.

That is, upper and lower pumping forces of lubricating fluids may be different by virtue of the auxiliary thrust dynamic-pressure grooves 243b formed in the upper and lower groove portions 248 and 249, that is, formed outwardly, in the radial direction; of top and lower surfaces of the sleeve 240 based on the circulation hole 247. The thrust dynamic-pressure grooves 243a that are formed in the upper and lower groove portions 248 and 249, that is, formed inwardly, in a radial direction, of top and lower surfaces of the sleeve 240 based on the circulation hole 247 may generate a levitation force of the rotation member or may circulate lubricating fluids, instead of generating a difference in the upper and lower pumping forces of the lubricating fluids. However, the present invention is not limited thereto and may be changed in various ways.

Thus, the auxiliary thrust dynamic-pressure grooves 243b that are positioned in a sealing portion with a small volume from among the upper sealing portion S3 and the lower sealing portion S4 may each have a greater pumping force than a thrust dynamic-pressure groove positioned in the other sealing portion. Accordingly, the lubricating fluids may be pumped towards a sealing portion with a great sealing volume and may be stored in the sealing portion.

The auxiliary thrust dynamic-pressure grooves 243b that are positioned in a sealing portion with a small sealing volume from among the upper sealing portion S3 and the lower sealing portion S4 may each have a smaller depth than a thrust dynamic-pressure groove positioned in the other sealing portion. Thus, the lubricating fluids may be pumped towards a sealing portion with a great sealing volume.

Furthermore, with regard to a grooved bottom surface positioned outwardly, in the radial direction, of top and lower surfaces of the sleeve 240 based on the circulation hole 247, an axial interval between the grooved bottom surface of the sleeve 240 and a thrust member positioned in a sealing portion with a small sealing volume from among the upper sealing portion S3 and the lower sealing portion S4 may be smaller than an axial interval between the grooved bottom surface of the sleeve 240 and a thrust member positioned in the other sealing portion. Thus, the lubricating fluids may be pumped towards a sealing portion with a great sealing volume.

In detail, referring to FIG. 9, when it is assumed that the lower sealing portion S4 that is positioned at a lower portion in the axial direction has a relatively great sealing volume, the lower grooved bottom surface 249a of the sleeve 240, positioned at the lower sealing portion S4 with a great sealing volume from among the upper sealing portion S3 and the lower sealing portion S4, includes a step portion 244 that is formed in an outer diameter direction of the sleeve 240, based on the circulation hole 247, and thus an axial interval between the lower thrust member 220 and the lower grooved bottom surface 249a may be greater than an axial interval between the upper thrust member 160 and the upper grooved bottom surface 248a. Accordingly, the auxiliary thrust dynamic-pressure grooves 243b that are positioned at an upper portion may have a relatively great pumping force, and thus lubricating fluids may be pumped towards the lower sealing portion S4.

According to the above embodiments of the present invention, the two spindle motors 100 and 200 are provided as the examples. However, the present invention is not limited thereto. The features of the present invention may be applied to various types of spindles motors that belong to the spirit and technical scope of the present invention.

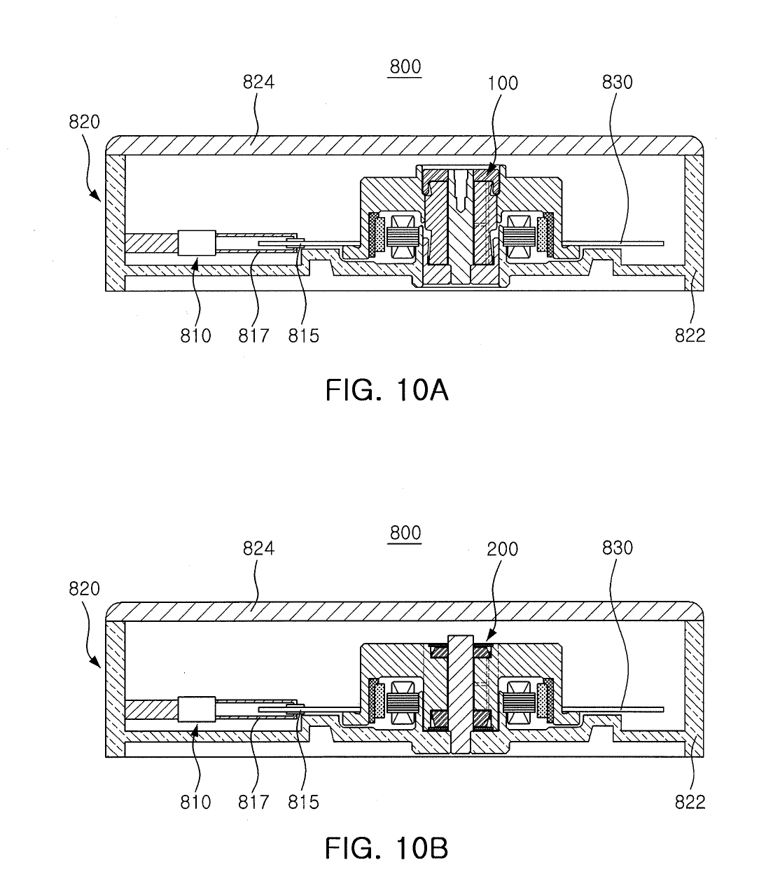

FIGS. 10A and 10B are schematic cross-sectional views of record-disk driving apparatuses 800 including motors 100 and 200, respectively, according to embodiments of the present invention.

Referring to FIGS. 10A and 10B, the record-disk driving apparatuses 800 including the motors 100 and 200 may each be a hard disk driving apparatus and may each include the motor 100 or 200, a head moving unit 810, and a housing 820.

The motors 100 and 200 may each have the above-described features according to the present invention. In addition, a record disk 830 may be mounted on each of the motors 100 and 200.

The head moving unit 810 may move a head 815 for detecting information of the record disk 830, mounted on each of the motors 100 and 200, to a surface of the record disk 830.

In this case, the head 815 may be positioned on a support unit 817 of the head moving unit 810.

The housing 820 may include a motor mounting plate 822 and a top cover 824 for shielding an upper portion of the motor mounting plate 822 in order to form an inner space for accommodating the motors 100 and 200 and the head moving unit 810.

As set forth above, according to the embodiments of the present invention, a spindle motor may include a sealing portion having a volume for storing a sufficient amount of lubricating fluid, thereby preventing a reduction in performance of a dynamic-pressure bearing assembly.

Thus, since a sufficient amount of lubricating fluid may be continually provided, the rotation characteristics of the spindle motor may be improved.

Effects of the present invention are not limited to the above-described effects. Thus, the present invention may have various effects according to embodiments of the present invention.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a lower thrust member fixed to a base member;
a shaft fixed to at least one of the lower thrust member and the base member;
a sleeve formed above the lower thrust member and provided to be rotatable with the shaft, the sleeve, together with the lower thrust member, forming a lubricating fluid liquid-vapor interface and forming a lower sealing portion;
a rotor hub coupled to the sleeve and rotating together with the sleeve; and
an upper thrust member fixed to an upper end portion of the shaft, the upper thrust member, together with the sleeve, forming a lubricating fluid liquid-vapor interface and an upper sealing portion,
either of the upper sealing portion and the lower sealing portion having a greater volume of sealed lubricating fluids than the other.

2. The spindle motor of claim 1, wherein an upper end portion of the sleeve includes an upper inclination portion, an external diameter of an upper portion of the upper inclination portion being greater than an external diameter of a lower portion thereof so that the upper inclination portion and the upper thrust member form together a liquid-vapor interface, and
wherein a lower end portion of the sleeve includes a lower inclination portion, an external diameter of a lower portion of the lower inclination portion being greater than an external diameter of an upper portion thereof so that the lower inclination portion and the lower thrust member form together a liquid-vapor interface.

3. The spindle motor of claim 2, wherein each of the upper thrust member and the lower thrust member includes a body having an inner surface coupled to the shaft and a protrusion portion that extends from the body and forms a liquid-vapor interface together with each of the upper inclination portion and the lower inclination portion.

4. The spindle motor of claim 1, wherein at least one of a bottom surface of the upper thrust member and a top surface of the sleeve or at least one of a top surface of the lower thrust member and a bottom surface of the sleeve includes thrust dynamic-pressure grooves formed therein.

5. The spindle motor of claim 4, wherein a thrust dynamic-pressure groove positioned in a sealing portion with a small sealing volume of lubricating fluid from among the upper sealing portion and the lower sealing portion has a greater lubricating fluid pumping force than a lubricating fluid pumping force of a thrust dynamic-pressure groove positioned in the other sealing portion.

6. The spindle motor of claim 5, wherein a thrust dynamic-pressure groove positioned in a sealing portion with a small sealing volume of lubricating fluid from among the upper sealing portion and the lower sealing portion has a smaller depth than a thrust dynamic-pressure groove positioned in the other sealing portion.

7. The spindle motor of claim 5, wherein an axial interval between the sleeve and a thrust member positioned in a sealing portion with a small sealing volume of lubricating fluid from among the upper sealing portion and the lower sealing portion is smaller than an axial interval between the sleeve and a thrust member positioned in the other sealing portion.

8. The spindle motor of claim 1, further comprising a circulation hole formed through a top surface of the sleeve to a bottom surface of the sleeve.

9. The spindle motor of claim 8, wherein at least one of a bottom surface of the upper thrust member and a top surface of the sleeve or at least one of a top surface of the lower thrust member and a bottom surface of the sleeve includes auxiliary thrust dynamic-pressure grooves formed outwardly, in a radial direction, of top and lower surfaces of the sleeve based on the circulation hole.

10. The spindle motor of claim 9, wherein the auxiliary thrust dynamic-pressure groove positioned in a sealing portion with a small sealing volume from among the upper sealing portion and the lower sealing portion has a greater lubricating fluid pumping force than a lubricating fluid pumping force of the thrust dynamic-pressure groove positioned in the other sealing portion.

11. The spindle motor of claim 10, wherein the auxiliary thrust dynamic-pressure groove positioned in a sealing portion with a small sealing volume of lubricating fluid from among the upper sealing portion and the lower sealing portion has a smaller depth than a thrust dynamic-pressure groove positioned in the other sealing portion.

12. The spindle motor of claim 10, wherein, for a portion positioned outwardly, in the radial direction, of the top and lower surfaces of the sleeve based on the circulation hole, an axial interval between the sleeve and a thrust member positioned in a sealing portion with a small sealing volume of lubricating fluid from among the upper sealing portion and the lower sealing portion is smaller than an axial interval between the sleeve and a thrust member positioned in the other sealing portion.

13. The spindle motor of claim 10, wherein an end portion of the sleeve, positioned in a sealing portion with a great sealing volume of lubricating fluid from among the upper sealing portion and the lower sealing portion, includes a step portion that is formed outwardly, in the radial direction, of the sleeve based on the circulation hole, and an axial interval between the sleeve and a thrust member positioned at the sealing portion is greater than an axial interval between the sleeve and a thrust member that is positioned in the other sealing portion.

14. The spindle motor of claim 8, wherein the circulation hole and a bearing gap formed by the sleeve and the shaft include a connection hole connected therebetween.

15. The spindle motor of claim 1, wherein the rotor hub includes:
a rotor hub body including an insertion portion into which the upper thrust member is inserted;
an installation portion that extends from an edge of the rotor hub body and has an inner surface on which a magnet assembly is installed; and
an extension portion that extends outwards in a radial direction from an end of the installing portion.

16. The spindle motor of claim 1, wherein the sleeve and the rotor hub are integrated together.

17. A spindle motor comprising:
a base member;
a shaft fixed to the base member;
a sleeve including a bearing unit installed to be rotatable with the shaft, and an upper groove portion and a lower groove portion formed in an upper portion and a lower portion of the sleeve, respectively;
upper and lower thrust members fixed to the shaft and respectively accommodated in the upper and lower groove portions, the upper and lower thrust members forming, outwardly in a radial direction, a lubricating fluid liquid-vapor interface, together with an inner circumferential surface of the sleeve, and forming upper and lower sealing portions, respectively; and
a rotor hub coupled to the sleeve and rotating together with the sleeve,
either of the upper sealing portion and the lower sealing portion having a greater volume of sealed lubricating fluid than the other.

18. The spindle motor of claim 17, wherein the sleeve and the rotor hub are integrated together.

19. The spindle motor of claim 17, wherein the upper thrust member includes an upper inclination portion, wherein an external diameter of an upper portion of the upper inclination portion is smaller than an external diameter of a lower portion thereof so that the upper inclination portion and the sleeve form together a liquid-vapor interface, and wherein the lower thrust member end portion of the sleeve includes a lower inclination portion, wherein an external diameter of a lower portion of the lower inclination portion is smaller than an external diameter of an upper portion thereof so that the lower inclination portion and the sleeve form together the liquid-vapor interface.

20. The spindle motor of claim 17, wherein at least one of a bottom surface of the upper thrust member and an upper grooved bottom surface of the sleeve or at least one of a top surface of the lower thrust member and a lower grooved bottom surface of the sleeve includes a thrust dynamic-pressure groove formed therein.

21. The spindle motor of claim 20, wherein the thrust dynamic-pressure groove positioned in a sealing portion with a small sealing volume from among the upper sealing portion and the lower sealing portion has a greater lubricating fluid pumping force than a lubricating fluid pumping force of the thrust dynamic-pressure groove positioned in the other sealing portion.

22. The spindle motor of claim 21, wherein the thrust dynamic-pressure groove positioned in a sealing portion with a small sealing volume of lubricating fluid from among the upper sealing portion and the lower sealing portion has a smaller depth than the thrust dynamic-pressure groove positioned in the other sealing portion.

23. The spindle motor of claim 21, wherein an axial interval between the sleeve and a thrust member positioned in a sealing portion with a small sealing volume of lubricating fluid from among the upper sealing portion and the lower sealing portion is smaller than an axial interval between the sleeve and a thrust member positioned in the other sealing portion.

24. The spindle motor of claim 17, further comprising a circulation hole formed from an upper groove portion of the sleeve to a lower groove portion of the sleeve.

25. The spindle motor of claim 24, wherein at least one of a bottom surface of the upper thrust member and an upper grooved bottom surface of the sleeve or at least one of a top surface of the lower thrust member and a lower grooved bottom surface of the sleeve includes auxiliary thrust dynamic-pressure grooves formed, outwardly in a radial direction, of top and lower surfaces of the sleeve based on the circulation hole.

26. The spindle motor of claim 25, wherein the auxiliary thrust dynamic-pressure groove positioned in a sealing portion with a small sealing volume from among the upper sealing portion and the lower sealing portion has a greater lubricating fluid pumping force than a lubricating fluid pumping force of the thrust dynamic-pressure groove positioned in the other sealing portion.

27. The spindle motor of claim 26, wherein the auxiliary thrust dynamic-pressure groove positioned in a sealing portion with a small sealing volume of lubricating fluid from among the upper sealing portion and the lower sealing portion has a smaller depth than the thrust dynamic-pressure groove positioned in the other sealing portion.

28. The spindle motor of claim 26, wherein, for a portion positioned outwardly, in the radial direction, of the top and lower surfaces of the sleeve based on the circulation hole, axial interval between a grooved bottom surface of the sleeve and a thrust member positioned in a sealing portion with a small sealing volume of lubricating fluid from among the upper sealing portion and the lower sealing portion is smaller than an axial interval between a grooved bottom surface of the sleeve and a thrust member positioned in the other sealing portion.

29. The spindle motor of claim 26, wherein a grooved bottom surface of the sleeve, positioned in a sealing portion with a great sealing volume of lubricating fluid from among the upper sealing portion and the lower sealing portion, includes a step portion that is formed outwardly, in the radial direction, of the sleeve based on the circulation hole, and
an axial interval between the grooved bottom surface of the sleeve and a thrust member at the sealing portion is greater than an axial interval between the grooved bottom surface of the sleeve and a thrust member that is positioned in the other sealing portion.

30. The spindle motor of claim 24, further comprising a connection hole through which the circulation hole and a bearing gap formed by the sleeve and the shaft are connected.

31. The spindle motor of claim 17, wherein the rotor hub includes:
a rotor hub body including an insertion portion into which the sleeve is inserted;
an installation portion extending from an edge of the rotor hub body and having an inner surface on which a magnet assembly is installed; and
an extension portion that extends outwards in a radial direction from an end of the installing portion.

32. A record-disk driving apparatus comprising the spindle motor of claim 1.

33. A record-disk driving apparatus comprising the spindle motor of claim 17.
